(19) United States
(12) Patent Application Publication
(10) Pub. No.: US 2007/0150321 A1
(43) Pub. Date: Jun. 28, 2007

(54) METHOD AND APPARATUS FOR INTERNET FEAST

(76) Inventors: YUANPING ZHAO, SAN JOSE, CA (US); YUANFAN ZHAO, KUNMING (CN); BIYUN ZHOU, SAN JOSE, CA (US)

Correspondence Address: YUANPING ZHAO;BIYUN ZHOU, 1947 TRENTON DRIVE, SAN JOSE, CA, 95124-1542, US

(21) Appl. No.: 11/615,973

(22) Filed: Dec. 23, 2006

Related U.S. Application Data
(60) Provisional application No. 60/754,238, filed on Dec. 27, 2005.

(51) Int. Cl. G06Q 10/00

(52) U.S. Cl. 705/5

(57) ABSTRACT

The present invention is directed to a method and apparatus for internet feast, or holding feast online. Internet media communications is utilized as feast platform on which the feast is held and feast related information is exchanged. Based on the worldwide speared of internet, feasters from different places could meet, chat, eat and enjoy together online. Many steps for feasting could be implemented and operated online, starting with making invitation, making appointment, making reservation for feast site, searching for menus, browsing food and drink, then making orders, distributing sub-orders, and ending with billing and payment. During the internet feast, food and drink are either served from local kitchen or delivered from nearby kitchen, after the orders are received online by internet food providers. The orders could be originated from one host feast site to multiple guest feast sites remotely. One single feast site is capable to order and enjoy multiple cuisines and food styles around the town, provided by different internet food providers.

### FIELD OF THE INVENTION

The present invention relates to internet based feast, and particularly to method and apparatus for feasters from different locations to hold online feast, meeting, chatting while enjoying food and drink together through internet media communications.

### BACKGROUND OF THE INVENTION

Generally, a feast makes feasters to meet, chat, eat and enjoy together. The feast must be held at a particular location where all the feasters could attend. For some feasters who are willing to join the feast but far away from feast site, they have to travel for feasting. The travel will cost money and time. Sometimes the feasters have to travel hours or even days to attend some important feasts that last only one or two hours, such as wedding ceremony, birthday party or anniversary. In case that long distance travel makes attending feast impossible, internet based feast would solve the problem.

During the era of globe economy, many globe companies run their business internationally and remotely, in terms of internal connections between departments or divisions, and/or external relationships with the globe customers. There is an increasing demand for holding feast among remote parties or groups. The remote feast site might be a single one, or might be multiple ones distributed globally. An internet based platform could be the best solution for such a worldwide feast. More economically, the cost of internet communications nowadays is much cheaper than the cost of travel and cost of time consumed for travel.

Technically, internet communications nowadays is capable of transmission audio video media and feast related message in real time. Internet feast could create a brand-new application field for internet services. In turn, traditional dining and feasting services could have a revolutionary change once internet communications technology is introduced.

In recent years, many applications have been made to utilize computer network for electronic commerce. U.S. Pat. No. 6,876,973 teaches using computer network for providing a searchable database of restaurants, and processing seat reservations automatically. Although it has mentioned “food order” and “credit card payment”, but no further service action is disclosed.

A computer integrated communication system for restaurants can be found in U.S. Pat. No. 6,973,437. This computerized communication network is only designed for restaurant wide service between customers and the restaurant wait-staff and management instead of worldwide feast service disclosed by this invention.

U.S. Pat. No. 5,845,263 also proposed an interactive ordering system with visual display or full-color images and mentioned with networked multimedia communications, but the function of such a system is only limited to order enhancement and marketing support; its service area is also limited to one restaurant, far from internet based feasting service disclosed by this invention.

Therefore, a novel method, along with an internet based platform, is desired that addresses the immediate and specific needs for online feasting service—customer-to-customer communication services among globally distributed feast sites for meeting, chatting, eating and enjoying together remotely without geographic limitation.

### BRIEF SUMMARY OF THE INVENTION

The present invention is a method and apparatus for internet feast, or holding feast online. Internet communications is utilized as a platform on which the feast is held and feast related information is exchanged. Based on the worldwide speared of internet, feasters from different places could meet, chat, eat and enjoy together online. Many steps of feasting could be implemented and operated online, starting with making invitation, making appointment, making reservation for feast site, searching for menus, browsing food and drink, then making orders, distributing sub-orders, and ending with billing and payment. During the internet feast, food and drink are either served from local kitchen or delivered from nearby kitchen, after the orders are received online by internet food providers. The orders could be originated from host feast site to multiple guest feast sites remotely. One single feast site is capable to order and enjoy multiple cuisines and food stiles around the town, provided by different internet food providers.

Therefore, it would be desirable that internet communications technology bring much benefit, efficiency, cost-effectiveness and enjoyment to the future online feast. There is no doubt that the present invention could revolutionize the feast we used to.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous features and advantages of the present invention may be better understood by those skilled in the art by reference to the accompanying figures in which:

FIG. 1 is a block diagram of internet feast platform in accordance with the present invention;

FIG. 2 is a table of a detailed plurality of Feaster Interface (FIF) in accordance with the present invention;

FIG. 3 is a block diagram of illustrating Feast Site Box (FSB) in accordance with the present invention;

FIG. 4 is a diagram of illustrating feast site layout in accordance with a preferred embodiment of the present invention;

FIG. 5 is a block diagram of illustrating Internet Food provider (IFP) in accordance with a preferred embodiment of the present invention;

FIG. 6 is a block diagram of illustrating action flow of internet feast in accordance with a preferred embodiment of the present invention;

FIG. 7 is a block diagram of illustrating operation flow of local order of internet feast in accordance with a preferred embodiment of the present invention;

FIG. 8 is a block diagram of illustrating operation of remote order of internet feast in accordance with a preferred embodiment of the present invention;

FIG. 9 is a block diagram of a software based embodiment of Feast Site Box (FSB) in accordance with the present invention;

FIG. 10 is a block diagram of a hardware based embodiment of Feast Site Box (FSB) in accordance with the present invention.

### DETAILED DESCRIPTION OF THE INVENTION

Reference will now be made in detail to the presently preferred embodiments of the invention, examples of which are illustrated in the accompanying drawings.

The present invention is directed to a method and apparatus for internet feast, or holding feast online. Internet media communications is utilized as feast platform on which the feast is held and feast related information is exchanged. Based on the worldwide speared of internet, feasters from different places could meet, chat, eat and enjoy together online. Many steps for feasting could be implemented and operated on feast platform.

In the following description, numerous specific descriptions are set forth in order to provide a thorough understanding of the present invention. It should be appreciated by those skilled in the art that the present invention may be practiced without some or all of these specific details. In some instances, well known process operations have not been described in detail in order not to obscure the present invention.

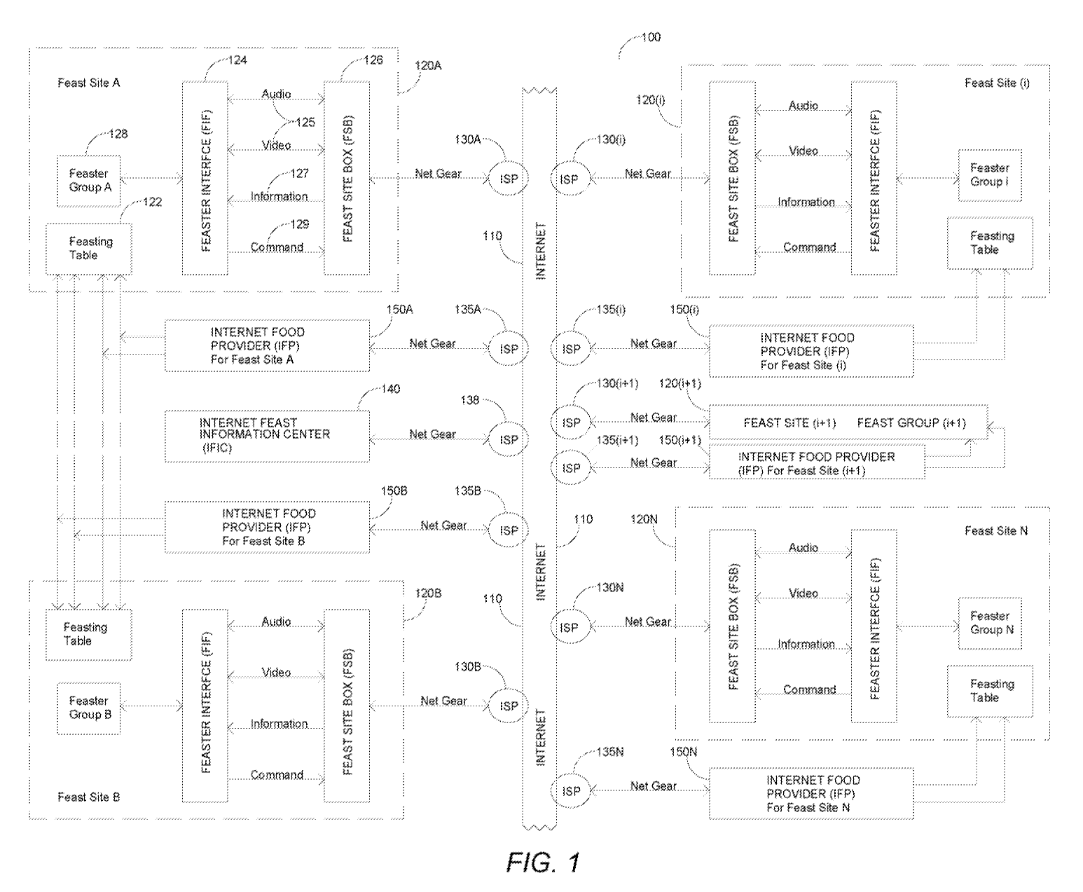

Referring to FIG. 1, a block diagram illustrating internet feast platform 100 in accordance with a preferred embodiment of the present invention is shown. Internet 110 could be used as a major media communication passage among a plurality of feast sites 120(A-N) (e.g., Feast Site A, Feast Site B, . . . , Feast Site [i], Feast Site [i+1], . . . , Feast Site N). There are N feast sites in FIG. 1. All the feast sites are coupled with internet 110 through their Internet Service Providers (ISPs) 130(A-N) by preferred net gear. At least one, but not limited to one, Internet Feast Information Center (IFIC) 140 is also coupled with internet 110 through its ISP 138 by preferred net gear. As a result, a plurality feast sites could communicate each other through internet 110. Any one of the feast sites could access the feasting related information from IFIC 140 through internet 110.

Internet Feast Information Center (IFIC) 140 comprises at least one, but not limited to one, master internet feast server that hosts the main entrance of internet feast web site. The master internet feast server stores web pages for feast related activities, such as menu searching, food and drink browsing. It is also executing application programs related to the feasting service, such as accepting feast orders, processing feast orders, distributing sub-orders to different internet Food Providers (IFPs), billing and payment processing, as well as payment distribution. As a master server that hosts the main entrance, it also contains a plurality of internet feast related database, search engine and platform management utility program. Other extended service utility programs may also operate in master internet feast server.

Internet feast database may comprise, but not limited to, feasting menu database, internet feast site database, internet food provider database and feasting culture database that may reflects feasting style, feasting tradition and feasting history.

Beside master internet feast server, IFIC may have a plurality of duplicated imaging servers distributed geographically.

Referring to FIG. 1 and taking Feast Site A (e.g., the block 120A) as an example, a feast site is a physical place where a group of feasters could meet, chat, eat and drink. Feast Site A is installed with all facilities supporting internet feast, including feasting table 122, Feaster Interface (FIF) 124 and Feast Site Box (FSB) 126. FSB 126 is coupled with internet 110 through ISP 130A by preferred net gear. A group of feasters 128 seat by the feasting table 122, their audio video information is captured into FSB 126 by FIF 124. FSB 126 could have the audio video information processed and compressed digitally into encoded media stream, then transmit the encoded media stream to other FSBs through internet 110. Encoded media stream from the other feast sites could also be received by FSB 126 through internet FSB 126 cold have the encoded media stream processed and decompressed into regular audio video format. FSB 126 then sends out audio video information 125 to FIF 124 for presentation. As a result, feasters seating in Feast Site A could watch video picture and listen to audio sound from other feast sites. FIF 124 also presents feast related information 127 to feasters 128, and sends their command 129 to FSB 126.

Other feast sites in FIG. 1 (e.g., block 120B, . . . , block 120[i], block 120[i+1], . . . , block 120N) may have similar structure and set-ups as Feast Site A (e.g., the block 120A), being coupled with internet 110 through their ISPs 130(B-N) by preferred net gear.

In other hand, each feast site is supported by a plurality of Internet Food Providers (IFPs) 150(A-N). Taking IFP for Feast Site A (e.g., the block 150A) as example, IFP 150A is coupled with internet 110 through its ISP 135A by preferred net gear. It accepts feast orders through internet, prepares food and drinks, and delivers them onto the feasting table 122 for feasters 128 to enjoy. In this way, feasters from different feast sites could be served with food and drink for feasting.

other IFPs in FIG. 1 (e.g., block 150B, . . . , block 150[i], block 150[i+1], . . . , block 150N) may have similar structure and set-ups as IFP for Feast Site A (e.g., the block 150A), being coupled with internet 110 through their ISPs 135(B-N) by preferred net gear.

Still taking Feast Site A as an example, Feast Site A (e.g., the block 120A) could be supported by either IFP for Feast Site A (e.g., the block 150A) or IFP for Feast Site B (e.g., the block 150B), or both of them. For receiving orders, all IFPs are coupled with internet 110 through their ISPs 135(A-N) by preferred net gear.

In present invention, a preferred net gear is an interfacing apparatus along with its physical connection to ISP. It could be either a RS-232 modem, ADSL modem, xDSL modem, cable modem, Wi-Fi terminal, fiber optic terminal, T1/T3 terminal or broadband gateway, depending on networking technology of ISP.

In most of the case, feasters are the source of audio and video information exchanged throughout the recasting internet. Other format of audio and video information might also be exchanged throughout the feasting internet while feast is in progress, such as business audio video presentation, commercial promotion, audio video entertainment, video on demand, internet gaming or Karaoke. The activities of feasters are not limited to eat and drink, other activities such as parties ceremonies, celebrations, entertainments, games, personal medial presentations, business presentations, product releases and commercial promotions may be held online among multiple feast sites.

For higher utilization, it is recommended that feast site be located at a public service facility such as hotel, restaurant, bar, club or convention center, making the feast platform and apparatus server more feasters efficiently.

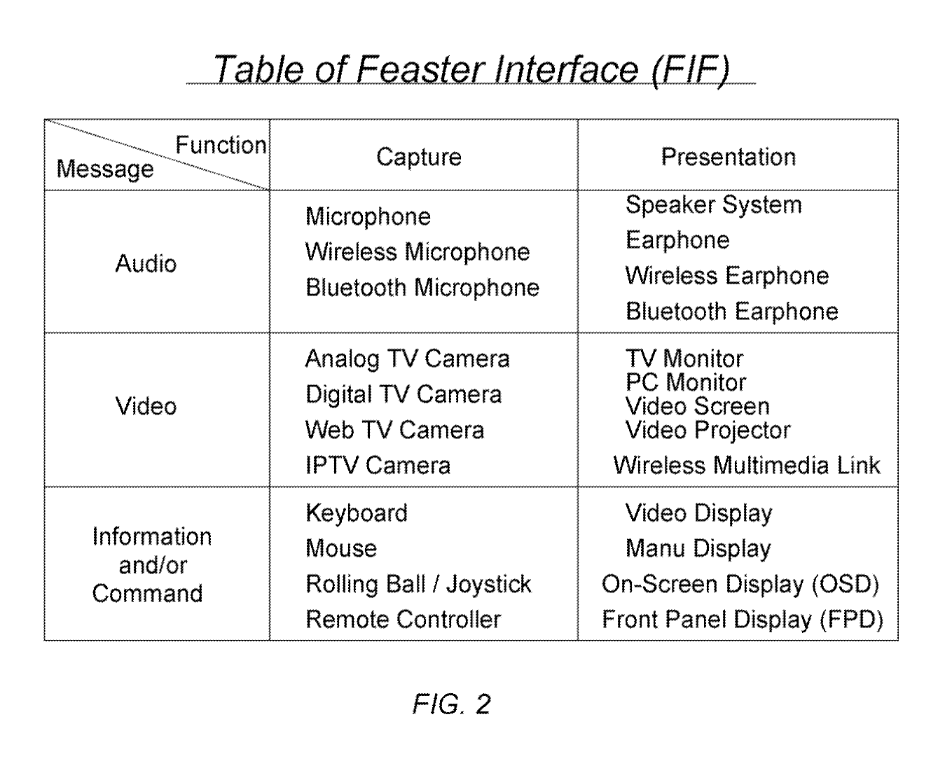

Referring now to FIG. 2, a table of a detailed plurality of Feaster Interface (FIF) in accordance with the present invention is shown. FIF is a plurality of audio video facilities that either captures feast information from feasters, or presents feast information to feasters. FIF exchanges feast information bi-directionally between feasters and Feast Site Box (FSB).

For audio information capture, FIF may contain microphone, wireless microphone, and/or Bluetooth microphone.

For audio information presentation, FIF may contain speaker system with its amplifiers, earphone, wireless earphone and/or Bluetooth earphone.

For video information capture, FIF may contain analog TV camera, digital TV camera, web TV camera and/or IPTV camera.

For video information presentation, FIF may contain TV monitor, PC monitor, video screen, video projector and/or related wireless multimedia link.

Beside audio and video, some other information also needs to be exchanged between feasters and FSB. In this case, FIF provides keyboard, mouse, rolling ball, joystick and/or Infra Red (IR) remote control for sending commands to FSB, and provides video display, menu display, on-screen display (OSD) and/or Front Panel Display (FPD) for presenting control and status information to feasters.

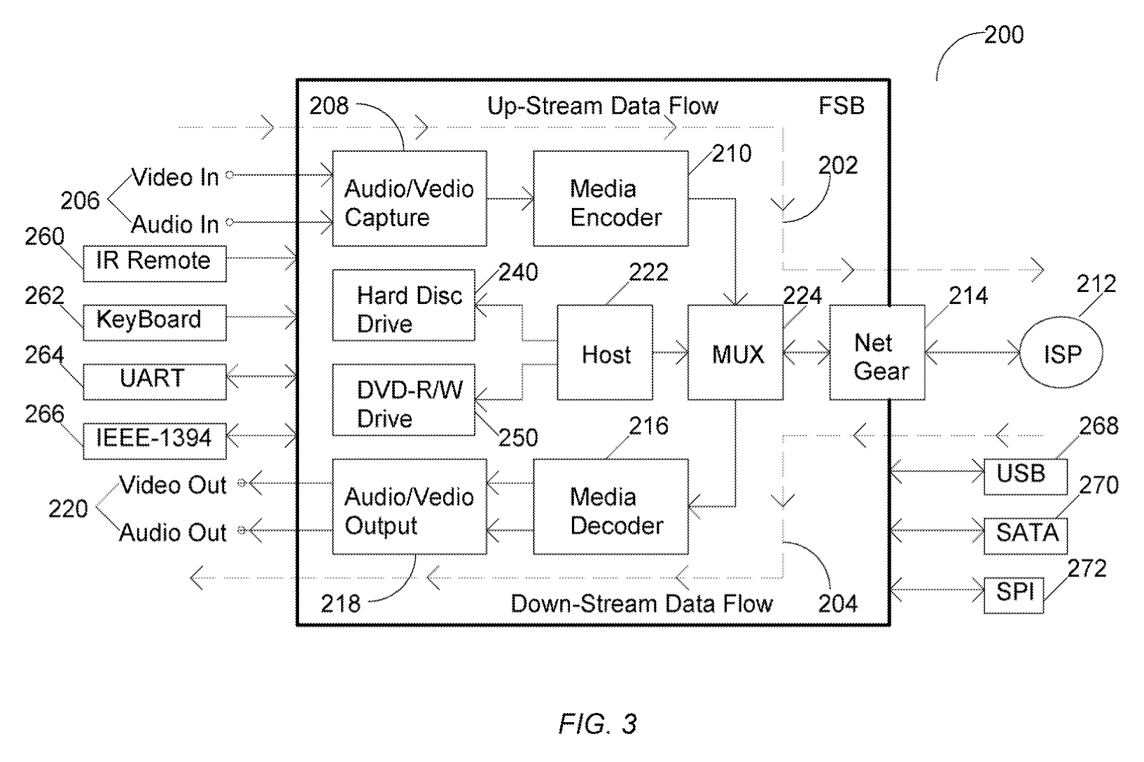

Referring now to FIG. 3, a block diagram illustrating Feast Site Box (FSB) 200 of the present invention is shown. For each feast site, Feast Site Box (FSB) is an important apparatus that handles internet feast information bi-directionally. Both up-steam data flow 202 and down-stream data flow 204 would be processed simultaneously by FSB 200. In up-stream processing, raw audio video signals 206 could be captured, sampled and digitized by an audio video capture circuit 208. Then the digitized audio video signals could be encoded into compressed multimedia stream by a media encoder 210. Next the compressed data stream is transmitted to the internet with ISP 212 through preferred net gear 214. In down-stream processing, the compressed multimedia stream could be received from internet through preferred net gear 214, and be decompressed into baseband audio and video by a media encoder 216. At last, the decompressed baseband audio and video 220 is sent to FIF by audio video output circuit 218. FIF would present audio video output 220 to the feasters. An embedded host processor 222 could control the overall system operations of FSB. A multiplexer 224 could be used to control media data stream bi-directionally.

In FSB, both audio video encoding and decoding would be implemented by multimedia encoder/decoder (Codec), which would have the capability to support dual stream and full duplex features. The encode/decode format would be MPEG-1, MPEG-2, MPEG-4, H.263+, H.264, DV-25 or JPEG. Video display format may be at a standard of NTSC, PAL or SECAM depending on country or region. Video display resolution may be 480i, 576i, 480p, 576p, 720p, 1080i or 1080p, depending on the bandwidth of ISP and its preferred net gear. Video output connections may be the form of CVBS, Y/C, RGB component, SMPTE YCbCr, VGA, SVGA, XVGA, DVI or HDMI. For audio processing, FSB could handle basic stereo channel inputs, and up to 8 channel audio outputs for 7.1 CH surrounding sound, with 16 to 24 bits per sample. In case wireless audio video link is required, UWB multimedia link could be used.

For large screen video display, high definition format is preferred. But if the bandwidth of ISP 212 is limited to some standard definition format, up-conversion could be made inside FBS as to increase the definition of video presentation.

Every FBS could be equipped with either Hard Disc Drive (HDD) 240 or DVD-Recordable/Rewritable drive (DVD-R/W) 250, or both of them, so as the multimedia streams in either or both directions could be recorded. As a value added service, feast video pictures and/or video footages could be recorded and delivered to feasters, in a format of either DVD-R/W media disc, online file transfer, or online document sharing. A regular Video Cassette Recorder (VCR) could also be used along with FSB for recording purpose.

FSB could provide enough Input/Output (I/O) ports for versatile connection to FIF. Low speed I/O ports could comprise IR remote control 260, keyboard 262, UART 264 and SPI 272. High speed I/O ports could comprise IEEE-1394 266, USB 268 and SATA 270 for feaster video plug-ins.

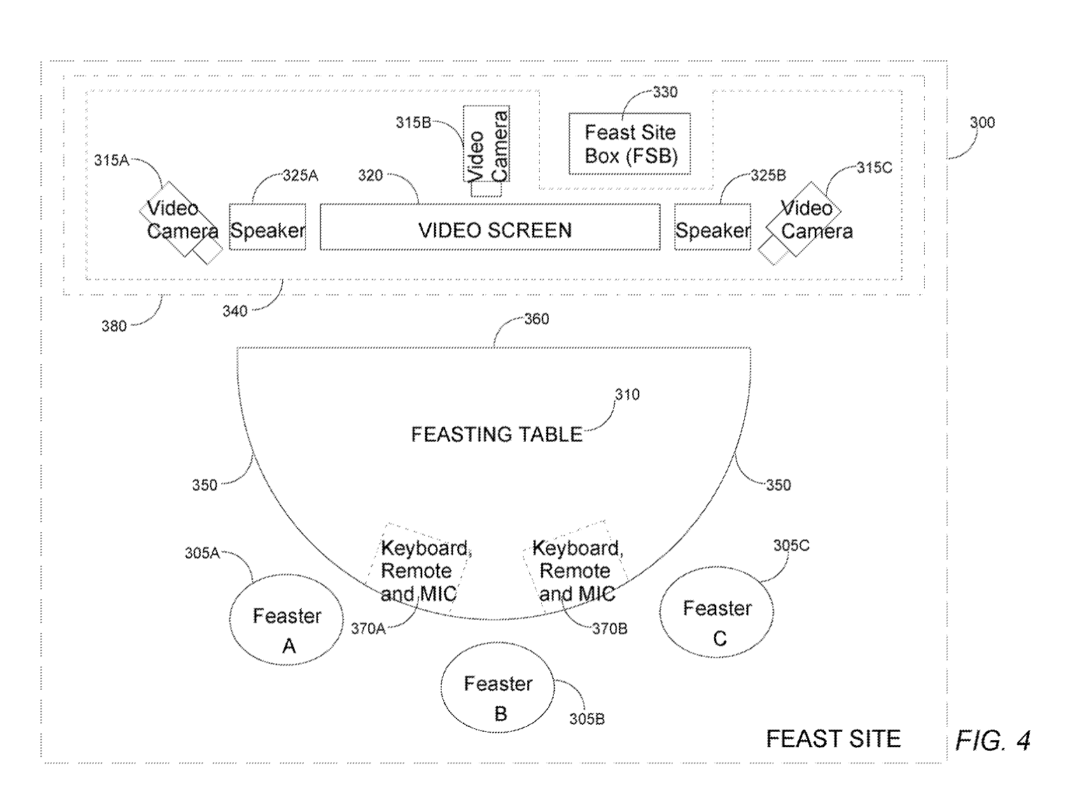

Referring now to FIG. 4, a diagram of illustrating a preferred embodiment of feast site layout 300 of the present invention is shown. A group of feasters, 305(A-C), would seat around the one side of the feast table 310. In the other side of the feasting table, a plurality of video cameras, 315(A-C), video display screen 320 and speaker system 325(A-B), are installed in front of the feasting table as the FIF 340. Every single piece of FIF connects feasters 305(A-C) to or from FSB 330. FSB 330 is then coupled with internet through its ISP by preferred net gear (not shown in FIG. 4).

In one embodiment of apparatus for the present invention, both FSB 330 and FIF 340 may be integrated into one assembly, deriving “All-Function-In-One” internet feasting machine, as shown in block 380 of FIG. 4.

In one preferred embodiment of feast table 310, the side for feasters to seat and eat could be in a round shape 350, while the side close to FIF 340 could be a straight-lined shape 360. These two sides make the feast table 310 a semi-round shape. A plurality of compartments and/or drawers, 370(A-B), could be installed under the table surface at feaster side. Inside the compartments and/or drawers other FIF facilities such as keyboard, mouse, rolling ball, joystick and microphones are installed within the reach of feasters. One or more remote controllers are also kept inside the compartments or drawers, 370(A-B).

For best video picture result, necessary lightening fixtures could be installed at feast site, as to illuminate the feasters and their background. The background could also be set up to feaster preferred format and scenery, such as the featured landscapes or the signature views of the city where the feast site is located.

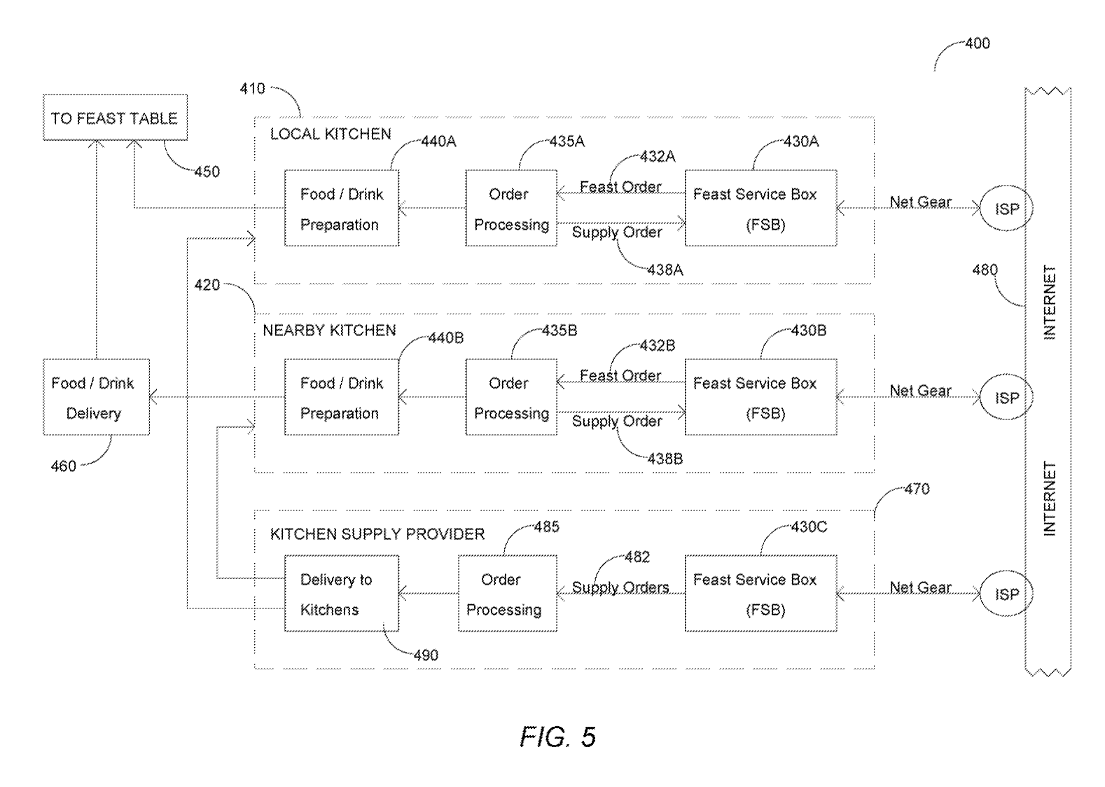

Referring to FIG. 5, a block diagram illustrating Internet Food Provider (IFP) 400 in accordance with a preferred embodiment of the present invention is shown. IFP 400 comprises both local kitchen 410 and nearby kitchen 420. Feast orders 432(A-B) are send into the kitchens from internet 480 through Feast Service Box (FSB) 430(A-B). Once the order is accepted and processed (e.g., the blocks 435[A-B]), food and drink would be prepared (e.g., the blocks 440[A-B]), and be delivered them onto the feasting table 450 for feasters to enjoy. Local kitchen 410 could serve the feasting table 450 directly, while nearby kitchen 420 could only serve the food and drink through delivery 460. Nearby kitchen might be located within a distance where the delivery would be feasible and the delivery time would be acceptable. With IFP service, the feast site itself might not possess a kitchen for food and drink, but it does have a plurality of food and drink service resources.

As an apparatus for IFP 400, both local kitchen 410 and nearby kitchen 420 have a FSB 430(A-B) coupled with internet 480, receiving and processing feast orders (e.g., the blocks 435[A-B]), so as cookers or food workers could make the food drink preparation (e.g., the blocks 440[A-B]) accordingly. The raw materials required for food drink preparation could be sub-ordered online from kitchen supply provider 470 nearby, using supply order channel 438(A-B), within the internet feast supply chain.

Kitchen supply provider 470 accepts supply orders 482 through FSB 430C, processes orders (e.g., the block 485), and have the supplies delivered to the kitchens (e.g., the block 490).

IFP could be an independent, separate part to feast site. This gives feasters much flexibility and wider food choices. One IFP may serve a plurality of feast sites. One feast site may be served by a plurality of IFPs. In this capacity, feasters within the same feast site may order food online from different IFPs around the town, enjoy different cuisines and food styles in one place. In fact, internet feast could make the dream “Enjoy the whole town within one place” become true.

In each IFP, Feast Service Box (FSB) is a similar apparatus as Feast Site Box (also FSB) installed at each feast site, so they could share the same name of FSB. As audio video is not so important to IFP, Feast Service Box (FSB) could be a sub-set of Feast Site Box (FSB) installed at each feast site with the same hardware architecture, but different application firmware and utility program.

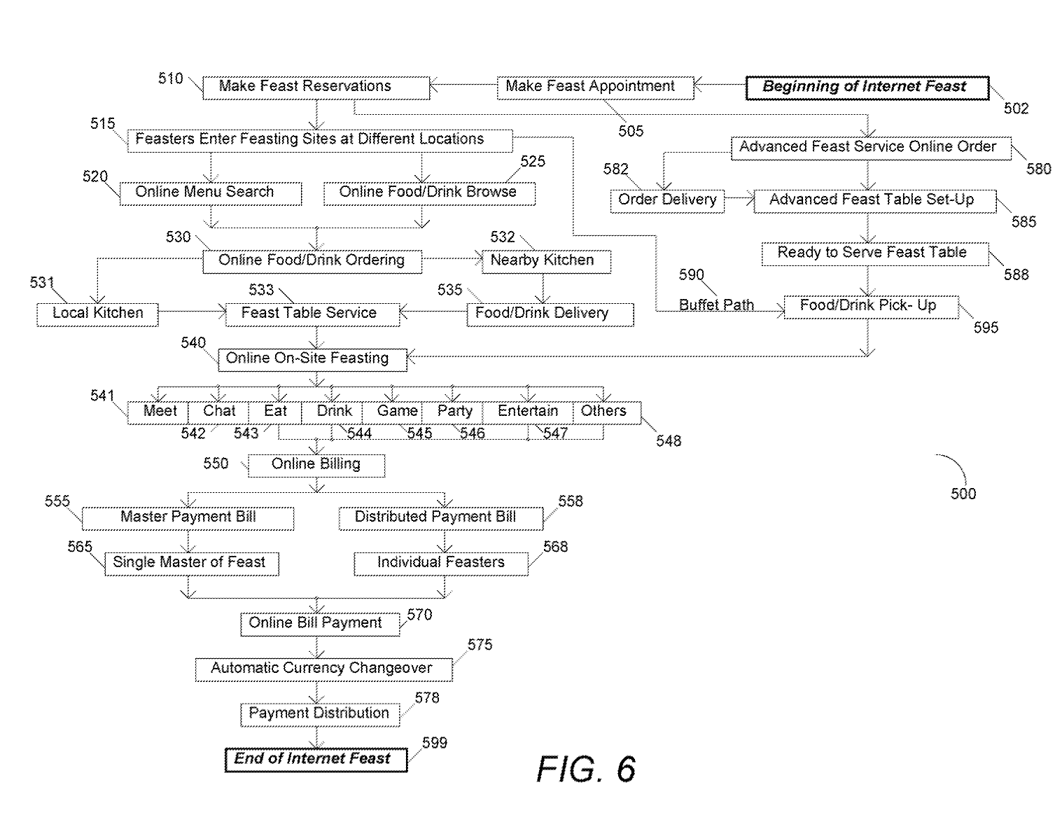

Internet feast platform makes meeting and chatting online while eating and enjoying possible. Based on the internet feast platform shown in FIG. 1, various online feast activities could be held. As an embodiment of present invention, an action flow diagram 500 illustrating detailed internet feast procedures is shown in FIG. 6. In one word, feasters could do anything that is possible online based on internet feast platform, and do the rests on feast site.

Internet feast begins as soon as feasters are thinking of getting together for feasting (e.g., the block 502). Firstly, feasters could make online feast appointment (e.g., the block 505). Online invitations and discussions would be happened for feast appointment. Once feast appointment is made, the feast schedule is determined and the feast site is selected, feasters would make feast reservation online (e.g., the block 510). One feast reservation may involve multiple feast sites, depending on the location where feasters are planning to attend the feast.

Secondly, feasters would enter the reserved feast sites according to the online reservation (e.g., the block 515). At each feast site, facilities could have been installed and laid out for internet feast (as shown in FIG. 4). To order the food and drink, feasters need to search for feast menus online (e.g., the block 520), or even browse the showcase and introduction of food and drink (e.g., the block 525). Once the choices of food and drink are made, online orders would happen (e.g., the block 530). The orders, of course, might cover every one of the feasters located at multiple involved feast sites. All the orders would be properly distributed as sub-orders through feast internet to multiple involved IFP comprising local kitchen 531 and nearby kitchen 532.

Thirdly, once IFP (531 and 532) receive distributed sub-orders online, they begin to prepare food or drink. After being cooked, toasted or blended, the food or drink is served onto the feast table (e.g., the block 533), or delivered onto the feast table (e.g., the block 535). As a result, feasters could pick up food and drink and enjoy online feasting (e.g., the block 540). Next the feasters could begin to enjoy the food and drink (e.g., the blocks 543 and 544) while meeting and chatting online (e.g., the blocks 541 and 542). Under such an online feast circumstances (e.g., the block 540), other activities like games, parties, ceremonies, celebrations, business presentations and commercial promotions could be held with great online and on-site enjoyments (e.g., the blocks 545 through 548).

Obviously, online meeting and chatting (e.g., the blocks 541 and 542) between feasters and/or feast sites could be happened any time during internet feast, before and after the order is made, before and after the food is served, before and after the food is consumed. So, online meeting and chatting must not be limited by the position of blocks 541 and 542 in the flow diagram 500. In fact, meeting and chatting could be involved in most activities during internet feast process. Therefore, the apparatus for internet feast disclosed in this invention must be such designed so as to always keep online audio video communication channels active.

Fourthly, after the online feast is done, online billing begins (e.g., the block 550). Bills would be generated online (e.g., the blocks 555 and 558) and distributed to the predetermined payees (e.g., the blocks 565 and 568). Either a single master of feast pays the whole bill covering multiple involved feast sites (e.g., the blocks 555 and 565), or co-masters pay the bills for their own feast sites. An extreme payment case would be each of the individual feasters paying its own bill individually (e.g., the blocks 558 and 568). All the involved feast payments could be made online (e.g., the block 570). In case the payment happens internationally, online currency changeover would be made automatically (e.g., the block 575), so that preferred currency could be accepted for the international feast payment.

At last, once all the payments are collected, they could to be distributed to all the involved Internet Feast Service Providers (IFSP) including, but not limited to, IFPs, delivery agents, wait-staff, feast site operators and internet feast operators (e.g., the block 578). Online balance transfer would complete all the payment distributions automatically. In case the payment distribution happens internationally, online currency changeover would be made automatically (e.g., the block 575). As a result, each involved internet feast service providers could receive the payment in its preferred currency. The end of internet feast happens once the payment distributions are completed (e.g., the block 599).

In case the feast is scheduled in a pre-ordered format like a buffet, the contents of feast could be ordered in advance (e.g., the block 580) once the reservation is made (e.g., the block 510), so as order delivery could be done if necessary (e.g., the block 582), and feast table would be set up in advance (e.g., the block 585), food and drink could be made ready before feast begins (e.g., the block 588). As a result, feasters could pick up food and drink (e.g., the block 595) and enjoy online feasting (e.g., the block 540) as soon as they enter feast site (e.g., the block 515) without delay and waiting for cooking and delivery, as shown by buffet path 590 in FIG. 6.

The feast orders traveling through internet have no geography limitation. Feast orders may be distributed to any feast site that has been registered for certain feast event. Festers may order for themselves locally, or may order food for feasters at other feast sites remotely. A local order would be served by local IFPs. A remote order is the order for at least one remote feast site, the food and drink service would be completed by the remote IFPs at or nearby remote feast site.

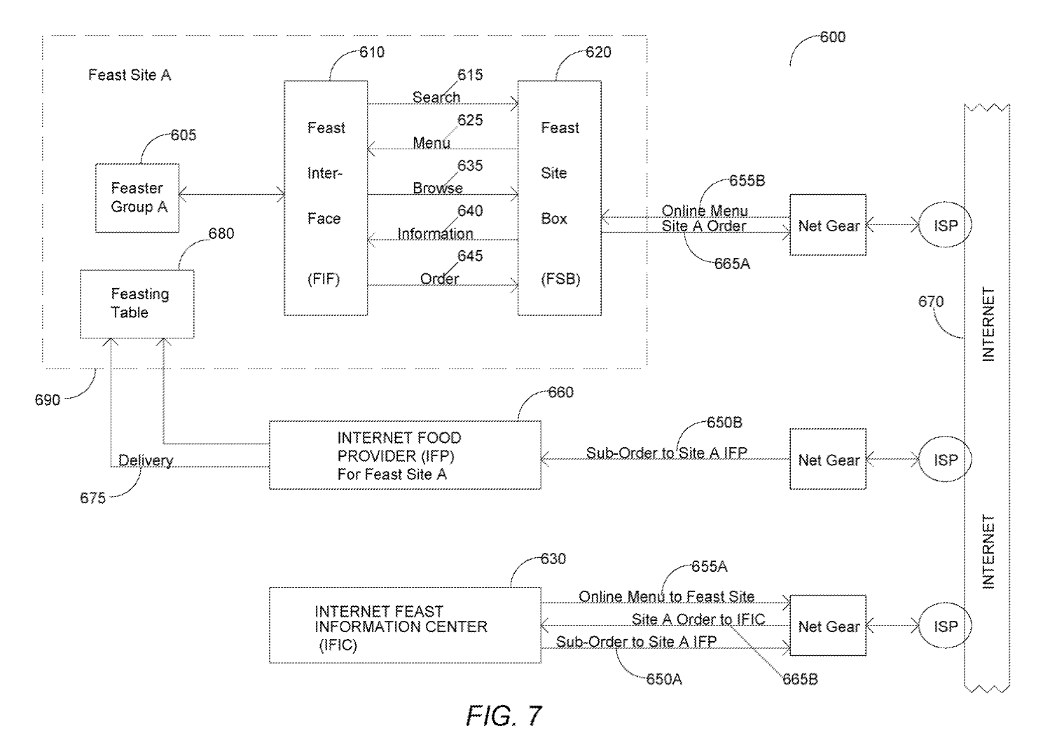

Referring to FIG. 7 and taking Feast Site A as example, block diagram 600 is shown illustrating local order in accordance with a preferred embodiment of the present invention. Before the orders could be made, feasters may search the menus for food and drink (e.g., the items 615 and 625). FIF 610, operated by feasters 605, generates search command 615 which is sent to FSB 620. FSB 620 then transmits search information, including the command and the keywords, to IFIC 630 through internet 670. Once IFIC 630 receives search information, embedded search engine is activated. The required menus would be picked out from the database, and be transmitted back to FSB 620 through internet 670 (e.g., the items 655A and 655B). Then feasters could browse menus (e.g., the items 635 and 625) and/or watch accompanying audio video presentation (e.g., the items 635 and 640) through FIF 610. Next, feasters 605 make the orders for themselves. They may use FIF 610 to generate order command 645, which is sends to FSB 620. FSB 620 then transmits order information, including the order command and a list of ordered items, to IFIC 630 through internet 670 (e.g., the items 665A and 665B). IFIC 630 would process the orders into sub-orders (e.g., the item 650A), and distribute sub-orders (e.g., the item 650B) to the involved IFP 660 through internet 670.

After receiving distributed sub-orders, each kitchen at IFP 660 would prepare food and drink accordingly, and have them served onto the feasting table 680 in case of local kitchen. In case IFP is a nearby kitchen, food and drink would be delivered to the feast site 690 first (e.g., the item 675), and then be served onto the feast table 680. The local order flow would be completed once all the ordered items have arrived the local feast table.

For example, in FIG. 7, the local order flow is originated from Feast Site A by Feaster Group A, completed at the same feast site (Feast Site A), with food and drink served by IFP for Feast Site A and consumed by Feaster Group A seating at Feast Site A. Feasters at Feast Site A also could meet and chat with other feast groups online while enjoying food and drink. After internet feast is done, the bills at Feast Site A for Feaster Group A could be paid by Feaster Group A itself, or be paid by other feast groups from other feast sites in case Feaster Group A is the guest of internet feast.

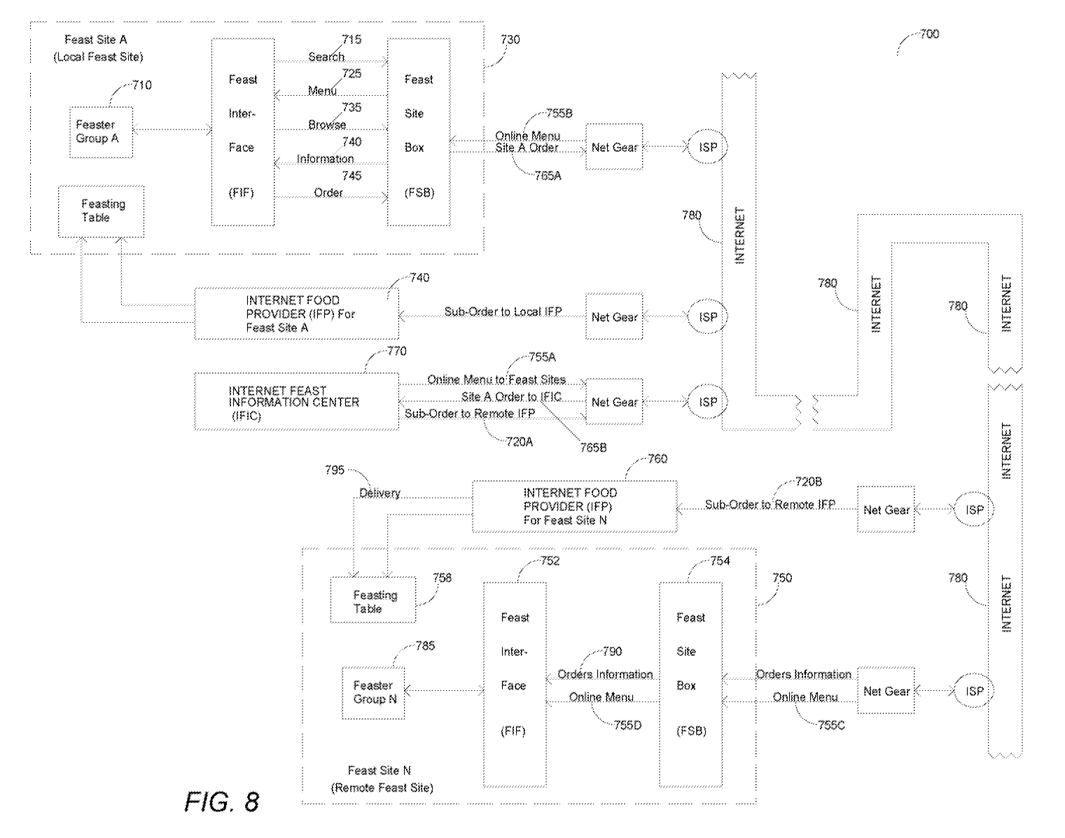

Referring to FIG. 8, block diagram 700 is shown illustrating remote order in accordance with a preferred embodiment of the present invention. As there is no geography limitation for both feast information and feast orders traveling through internet, remote order operation flow 700 has almost the same procedures and operations as local order, in terms of menu searching (e.g., the items 715 and 725), food and drink browsing (e.g., the items 735 and 740) and online ordering (e.g., the items 745). Something different is remote order involves at least two geographically separated feast sites, Feast Site A (e.g., the block 730) and Feast Site N (e.g., the block 750). Remote orders are always made for remote feasters seating at the other feast sites. The feast orders might be originated from the first feast site 730, and be completed at the second feast site 750 located at a different geography area, or vise versa.

During menu search process, IFIC 770 could send the menus to all the feast sites that have been registered for certain feast event, no matter the feast site is local or remote. For example, in FIG. 8, online menu 755A is generated and sent out to internet 780 by IFIC 770. Feast Site A (e.g., the block 730), as a local feast site, could receive it (e.g., the item 755B); Feast Site N (e.g., the block 750), as a remote feast site, could also receive it (e.g., the items 755C and 755D) in a predetermined manner.

No matter where the remote feast sites are located at, the remote orders would be completed by IFPs that are local to or nearby the remote feast sites. For example, in FIG. 8, IFP 740 serves Feast Site A (e.g., the block 730) and IFP 760 serves Feast Site N (e.g., the block 750). As soon as remote orders are originated from Feast Site A (e.g., the block 730) by Feast Group A (e.g., the block 710), IFIC 770 would have Feast Site A orders (e.g., the items 765[A-B]) processed, and have the sub-orders (e.g., the items 720[A-B]) distributed to the involved remote IFP 760 through internet 780. After receiving distributed sub-orders (e.g., the items 720B), each kitchen at remote IFP 760 would prepare food and drink accordingly, and have them served onto the remove feast table 758 in case remote feast site has a local kitchen. In case remote IFP 760 has a nearby kitchen to the remote feast site 750, food and drink would be delivered to the remote feast site 750 first (e.g., the items 795) and then be served onto the remote feast table 758. The remote order flow would be completed once all the remote ordered items have arrived the involved remote feast tables.

Still in FIG. 8, the remote order flow 700 is originated from Feast Site A by Feaster Group A, completed at Feast Site N, with feed and drink served by IFP for Feast Site N and consumed by Feaster Group N (e.g., the block 785) seating at Feast Site N. Even before food and drink arrive Feast Site N, Feaster Group N (e.g., the block 785) could find out order information for them (e.g., the item 790) through FIF 752 and FSB 754. They also could meet and chat with other feast groups online while enjoying food and drink. After internet feast is done, the bills at Feast Site N for Feaster Group N could be paid by Feaster Group A from Feast Site A. In this case, Feaster Group A from Feast Site A is the host of internet feast, while Feaster Group N from Feast Site N is the guest of internet feast.

In turn, Feaster Group N from Feast Site N could also host internet feast, making remote orders and paying the bills for other feaster groups seating at other feast sites as the guests of internet feast (not shown in FIG. 8).

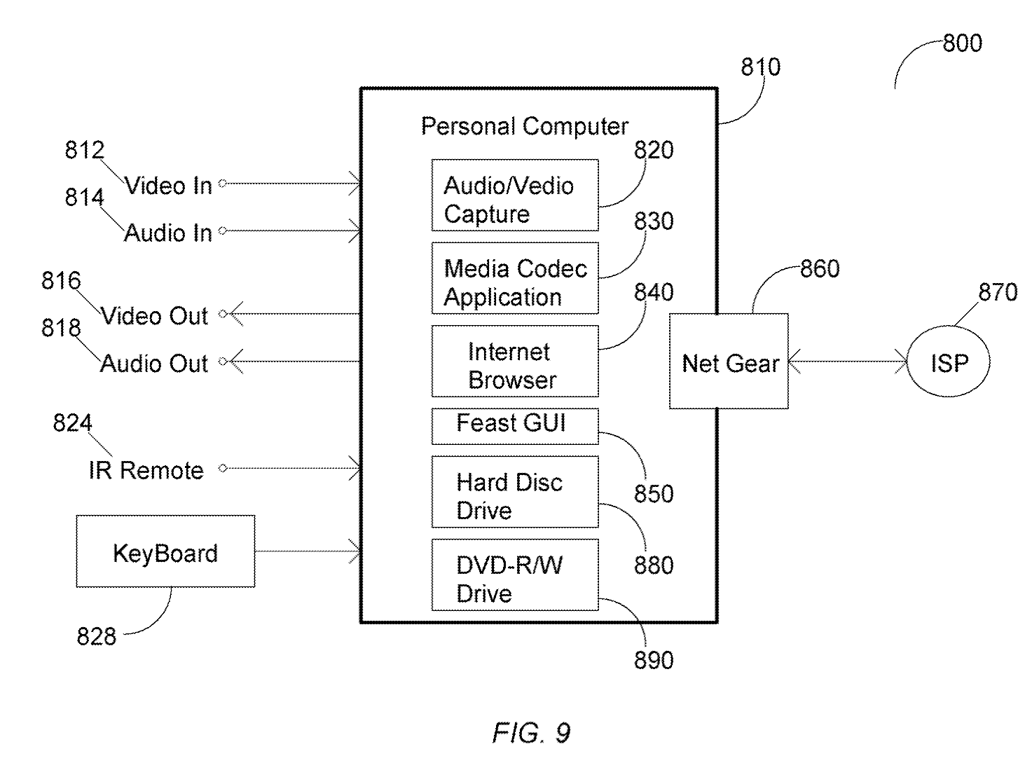

In an embodiment of apparatus for the present invention, FSB could be implemented with software based solution, as shown in FIG. 9. Software based embodiment means the major multimedia processing functions are implemented by software applications such as media Codec and internet browser, while the hardware platform for the software based FSB 800 is a general purpose personal computer (PC) 810. The general purpose PC 810 should be such configured, in terms of CPU speed and memory size, as to have the required capability for real-time multimedia Codec processing.

In FIG. 9, audio video capture block 820 could be a high speed PC add-in hardware card. It digitizes and samples analog video input signals 812 from cameras, or recondition digital video signals for digital TV cameras. In case IPTV cameras are used, an Ethernet interface card could be used as media capture card. Each of the above media capture cards would handle more than one channel of video, preferably three to four channels of video inputs.

As an example, for media Codec application software 830 inside the software based FSB 800, Windows Media 9 Series by Microsoft Corp. of Redmond, Wash. could be utilized. This Windows based media processing tool package could deliver standard definition video at bit rates ranging 1.5 to 1.8 Mega-Bits per second, and could be operated friendly to computer network or internet. Other media Codec application software developed by other manufacturers may be used whenever they could provide the capabilities required by FSB.

For browsing feast internet, at least one internet browser 840 could be installed. One good example could be Internet Explorer, also by Microsoft Corp. of Redmond, Wash. For most of PC, Internet Explorer is a bundled package with PC's Windows operation system. Other internet browser software developed by other manufacturers may be used whenever they could provide the capabilities required by FSB.

To make use of capacity of general purpose PC 810, a dedicated Graphic User Interface (GUI) 850 for feasting could be installed, which presents feast video 816 and other graphic information to feasters. Audio input 814, audio output 818 and keyboard 828 are standard hardware for a general purpose PC 810, but IR remote control function 824 must be installed to PC 810.

To a general purpose PC, preferred net gear 860 could be plugged in easily, as to make the software based FSB 800 coupled with internet through ISP 870.

Either hard disc drive 880 or DVD-R/W drive 890, or both of them, could be installed into the software based FSB 800 so as to record the interested feast multimedia stream.

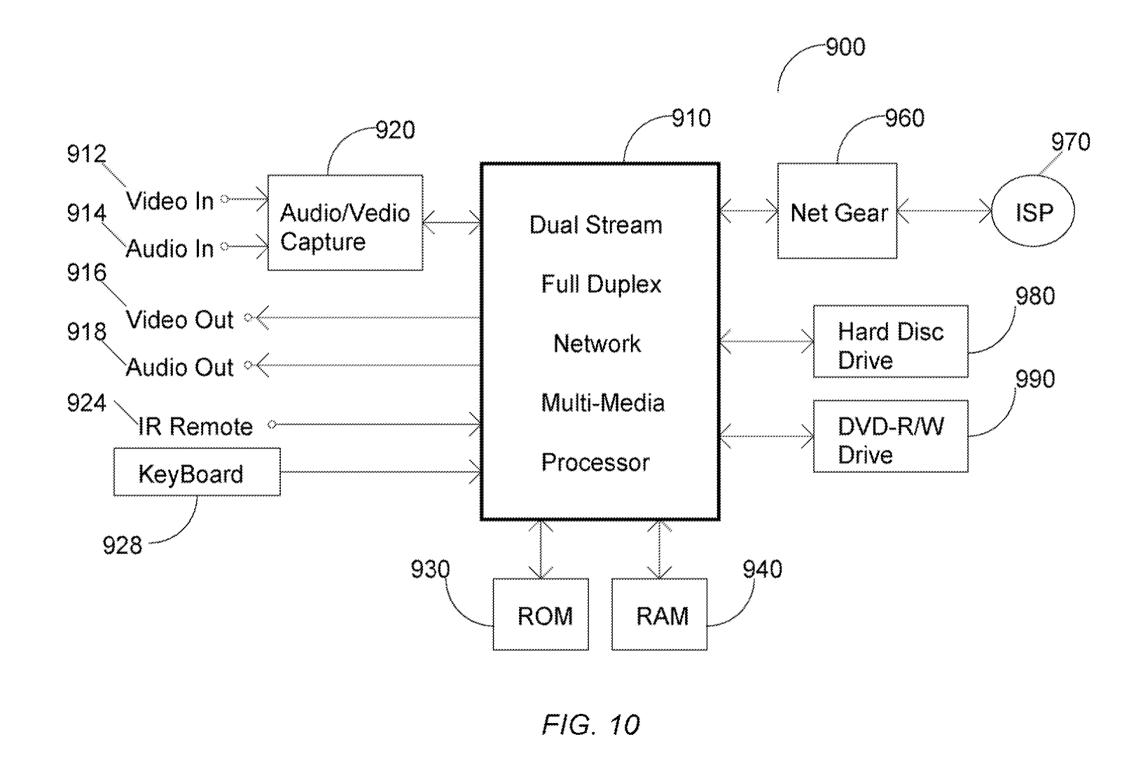

In another embodiment of apparatus for internet feast, FSB could be implemented with hardware based solution, as shown in FIG. 10. Hardware based embodiment means the major multimedia processing functions are implemented by electronic hardware and/or semiconductor integrated circuit chips. Generally, Codec and multimedia processors could be integrated into semiconductor chip nowadays and one single silicon chip could contain a large scale electronics system. Thus we have the term of System-on-Chip, or SoC. SoC would make hardware based FSB possible.

In FIG. 10, hardware based FSB 900 is dominated by a SoC network multimedia processor 910 with dual stream and full duplex features. A plurality of memories could be attached to the multimedia processor for storage purpose. Read Only Memory (ROM) 930 could be used to store system firmware and instruction code. Random Access Memory (RAM) 940 could be used to store media data streams, digital video frames and graphic planes. Control command from IR remote control 924 and data input from keyboard 928 are also interfaced to the multimedia processor 910.

Among choices of multimedia processors available from the market, Domino network multimedia processor developed by LSI Logic Corporation of Milpitas, Calif. could be one of the choices. Domino network multimedia processor is a single chip, multi-stream, multi-format, multi-service MPEG audio video system Codec architecture. It integrates all the function blocks required by FSB 900 into the same chip, reducing cost, design complexity, power consumption, and time-to-market. Its media Codec is capable of supporting MPEG-1, MPEG-2, MPEG-4, and H.263+ video formats. Domino's dual 150 MIPS RISC processors provide the necessary horsepower for host functions and additional graphic processing. The integrated IEEE-1394 link interface makes it easy to hook up with network. Domino chips also support large memory bandwidth of up to 64 M-Bytes of SDRAM, in both single data rate (SDR) and double data rate (DDR) formats. The 32-bit, 148.5 MHz memory bus could have a maximum bandwidth of 1.2 G-Bytes, able to meet the most challenging applications such as dual stream high definition encoding and decoding. As a result, Domino chip is capable of streaming standard definition video pictures into 1.3 Mega-Bits per second data flow.

As an example shown in FIG. 10, in FSB 900, multimedia processor 910 could use DMN-8623, the latest part from LSI's Domino chip family. ROM 930 could be implemented by flash memory so that its content could be updated remotely through internet. RAM 940 could be implemented by DDR SDRAMs with 32-bit bus width and 8 to 64 M-Bytes sizes depend on the required video definition. Low speed I/O ports are ready to connect with IR remote control 924, as well as the keyboard 928. In case the audio input 912 and video input 914 are of analog format, a media capture chip 920 would be required to digitize the signals. DMN-8623's, video output 916 could directly drive into the most of the display formats available from the market, including CVBS, Y/C, RGB component, SMPTE YCbCr, VGA, SVGA or XVGA. For audio output 918, DMN-8623 could provide up to 8 channels of surrounding sound.

To hardware based FSB 900, a preferred net gear 960 could be designed in, as to make it coupled with internet through ISP 970.

Either hard disc drive 980 or DVD-R/W drive 990, or both of them, could be installed into the hardware based FSB 900 so as to record the interested feast multimedia stream.

Other multimedia processors developed by other manufacturers could be utilized whenever they could provide the capabilities required by FSB. For example, PR818S is a multimedia processor developed by SigmaTel, Inc. of Austin, Tex. This chip could support full duplex operations with an ASP/SP MPEG-4 audio video Codec engine, and a built-in ARM922T RISC core. It could even interface with CCD/CMOS camera directly, resulting some extend of integration between FIF and FSB. Another multimedia Codec example is VW2010 chip developed by Vweb Corporation of San Jose, Calif. This chip has full duplex MPEG-1, MPEG-2, MPEG-2 Codec and a 5-plain OSD graphic engine. It also has PCI interface for host connection to a PC. Obviously, VW2010 chip could support software and hardware combined embodiment of apparatus for internet feast disclosed as follows.

Still another embodiment of apparatus for internet feast, FSB could be implemented with the combination of both software based and hardware based embodiments. In this embodiment, internet accessing and browsing could be implemented by a multimedia PC and the preferred software applications and GUI for feasting, while multimedia processing functions and dual stream Codec could be implemented by electronic hardware or Codec integrated circuits mentioned above. As a result, one or more hardware plug-in card with dual stream full duplex multimedia processing functions could upgrade a multimedia PC into FSB. Video display could have either PC monitor or TV monitor, or even both of them.

In case dual stream full duplex multimedia processor is not available, at least two single stream multimedia processors could be utilized for hardware based embodiment. The first single stream multimedia processors could function as dedicated multimedia encoder, providing out coming compressed media stream. The second single stream multimedia processors could function as dedicated multimedia decoder, decoding incoming compressed media stream into regular media data flow.

Advantageously, the present invention could revolutionize the feast we used to. Firstly, the present invention could let the feasters, geographically separated from each other, feast together without traveling, as if they were meeting each other and doing face-to-face communications.

Secondly, the present invention could make the hosts treat their guests remotely with a feast that was impossible. This may save time and money for those hosts who would refresh their relationship with the feasters, usually the friends, the customers or the employees of the hosts. Thirdly, the present invention could let the feasters enjoy multiple cuisines and food styles within a single feast site, no more need to hunt different cuisines and food styles around the town. Fourthly, the present invention could promote the involved business, as internet could extend the involved business to a new kingdom. For example, an IFP with limited operation site could serve multiple feast sites nearby, resulting a much larger virtual operation site.

At last, the present invention could benefit the whole involved business chain. The businesses that would benefit from internet feast could include, but not limited to, hotels, bars, clubs and convention centers as feast site providers; kitchens and restaurants as IFPs; delivery agents for IFP; FIF manufacturers and vendors; FSB developers and manufacturers; feast site builders; feast web site composers; internet feast operators and their ISPs. It is no doubt that the present invention would open up a new realm for internet applications, and create new life style for feasters. It also would push internet technology forward to larger capacity, wider bandwidth and faster media access.

It must be mentioned that apparatus of this invention is configured for customer-to-customer communication service. Although it appears to be a special application of IPTV, it has some advantage over IPTV. Technically, internet feast uses internet protocol to exchange multimedia message like IPTV. But it doesn't need a broadcaster like IPTV, nor a large party of audience. Except the embedded audio and/or video on demand services, it also doesn't require contents and content providers.

In fact, feasters who enjoy internet feast have become both the broadcaster and the content provider of such a special customized IPTV system. As a result, internet feast is much easier to implement than IPTV, is much cheaper to operate than IPTV. Obviously, internet feast is much easier to obtain investment return than IPTV. Since the content involved in this invention is self-provided by the feasters, therefore, feasters don't have to pay for the content copyright fee, nor any third-party license fee.

It is believed that the internet feast method and apparatus of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the future claims to encompass and include such changes.

What is claimed is:

1. A method for holding internet feast remotely comprising the steps of:
(a) making online invitation for internet feast;
(b) making online appointment for internet feast;
(c) making online reservation for internet feast site;
(d) entering feast site according to the reservation;
(e) searching online for menus of food and drink served for internet feast;
(f) browsing online description, showcase and introduction of food and drink through the feasting platform;
(g) making online orders for food and drink through the feasting platform based on the searching and browsing result;
(h) distributing sub-orders to proper internet food providers through the feasting platform;
(i) preparing the food and drink by internet food providers according to online orders;
(j) delivering the ordered food and drink from internet food providers to the feast sites for feasters to enjoy;
(k) feasters enjoying the food and drink while meeting remotely and chatting online through the feasting platform;
(l) generating bills online once internet feast is completed;
(m) distributing the bills to multiple feast sites online through the feasting platform;
(n) collecting payments online through the feasting platform;
(o) distributing the incomes to all the involved internet feast service providers including internet food providers, delivery agents, waiters and internet feast operators; and
(p) delivering feast video pictures and/or video footages to feasters.

2. The method according to claim 1, a plurality of feasters could converge at one of the interconnected feast sites, enjoying the food and drink while meeting remotely and chatting online with other plurality of feasters seating at other interconnected feast sites.

3. The method according to claim 1, at any interconnected feast site, the activities of feasters are not limited to eat and drink, other activities such as parties, ceremonies, celebrations, entertainments, personal media presentations, business presentations, product releases and commercial promotions could be held online among a plurality of feast sites.

4. The method according to claim 1, feasters may search for feast menus provided by the feasting platform in order to order the food and drink, or even browse the showcase and introduction of food and drink.

5. The method according to claim 1, the orders may be generated locally, from one feast site to the feasters located at the same feast site, and be served by at least one, but not limited to one, local or nearby internet food provider.

6. The method according to claim 1, the orders may be originated from one feast site by the host feasters to the guest feasters located remotely at a plurality of interconnected feast sites, and be served by remote internet food providers which are local to or nearby the remote feast sites.

7. The method according to claim 1, all the feast orders would be properly distributed as sub-orders through internet feasting platform to a plurality of involved, no matter local or remote, internet food providers which are local to or nearby the feast sites to be served.

8. The method according to claim 1, once the plurality of internet food providers receive distributed sub-orders online, they begin to prepare food and drink accordingly, and then serve or deliver food and drink onto the feast table at each feast site.

9. The method according to claim 1, after the online feast is completed, all the feast related finance activities could be completed online, with bills being generated online and distributed to predetermined payees.

10. An apparatus comprising:
(a) means for holding internet feast remotely;
(b) means for making online invitation for internet feast;
(c) means for making online appointment for internet feast;
(d) means for making online reservation for internet feast site;
(e) means for searching online for menus of food and drink served for internet feast;
(f) means for browsing online description, showcase and introduction of food and drink through the feasting platform;
(g) means for making online orders for food and drink through internet feast platform based on the searching and browsing result;
(h) means for distributing sub-orders to proper internet food providers through the feasting platform;
(i) means for preparing the food and drink by internet food providers according to online orders;
(j) means for delivering the ordered food and drink from internet food providers to the feast sites for feasters to enjoy;
(k) means for feasters enjoying the food and drink while meeting remotely and chatting online through the feasting platform;
(l) means for generating bills online once internet feast is completed;
(m) means for distributing the bills to predetermined payees online through the feasting platform;
(n) means for collecting payments online through the feasting platform;
(o) means for distributing the incomes to all the involved internet feast service providers including internet food providers, delivery agents, waiters and internet feast operators; and
(p) means for delivering feast video pictures and/or video footages to feasters.

11. An apparatus of internet feast comprising:
a plurality of feast sites;
a plurality of internet food providers;
at least one, but not limited to one, internet feast information center coupled with said platform through internet or worldwide web site;
a plurality of interconnections between the plurality of feast sites and said internet feast platform through internet or worldwide web site; and
a plurality of interconnections between the plurality of internet food providers and said internet feast platform through internet or worldwide web site.

12. The apparatus according to claim 11, wherein said feast site is a physical place comprising:
at least one, but not limited to one, feasting table with chairs for feasters to seat and eat;
a first plurality of feaster interface that captures audio video media information from feasters to said internet feast platform;
a second plurality of feaster interface that presents audio video media information to feasters from said internet feast platform;
at least one, but not limited to one, feast site box that processes bi-directional audio video media incoming stream and out coming stream; and
a net gear that couples said feast site to internet feast platform through internet service provider.

13. The apparatus according to claim 11, wherein said internet food provider comprising:
a local kitchen that is located at the feast site and interconnected with said platform through internet or worldwide web site;
a plurality of nearby kitchens that is located around the feast site in a distant within which food delivery is feasible, and interconnected with said platform through internet or worldwide web site;
a plurality of nearby restaurants, bars and deli shops that is located around the feast site in a distant within which food delivery is feasible, and interconnected with said platform through internet or world wide web site;
a plurality of feast service boxes that interfaces said kitchens and food workers to internet feast platform; and
food delivery services.

14. The apparatus according to claim 11, wherein said internet feast information center comprising:
at least one, but not limited to one, master internet feast server that hosts the main entrance of internet feast web site;
a plurality of internet feasting menu database;
a plurality of internet feast site database;
a plurality of internet food provider database;
a plurality of feasting culture database;
a plurality of internet feasting service applications such as order processing, order distribution, billing, payment processing and income distribution;
at least one internet feasting web site search engine; and
a net gear that couples said internet feast information center to internet feast platform through internet service provider.

15. The apparatus according to claim 12, wherein said feasting table comprising:
a first side by which feasters could seat and eat;
a second side that faces to a plurality of feaster interface;
a curved shape at the first side for feasters to seat by;
a straight-lined shape at the second side facing to a plurality of feaster interface;
an overall look of a semi-round shape;
at least one, but not limited to one, compartment built into the first side where feasters could reach;
a plurality of feaster interface facilities such as keyboard, mouse, rolling ball or joystick installed inside said compartment; and
a plurality of handheld remote controllers kept inside said compartment.

16. The apparatus according to claim 12, wherein said feaster interface comprising:
a plurality of media capture facilities that capture feast information from feasters in audio video format;
a plurality of media presentation facilities that presents feast information to feasters in audio video format;
a plurality of command input facilities that accepts control information from feasters; and
a plurality of information presentation facilities that interacts with feasters.

17. The apparatus according to claim 12, wherein said feast site box comprising:
capability to handles internet feast information bi-directionally;
capability to capture feast information from feasters through said feaster interface;
capability to present feast information to feasters through said feaster interface;
capability to process both up-stream and down-stream simultaneously;
at least one audio video media encoder that compresses media stream into lower data rate;
at least one audio video media decoder that decompresses media stream into required data rate;
at least one host microprocessor system with required memories; and
a net gear that couples said feast site to internet feast platform through internet service provider.

18. The feast site box described in claim 17, wherein its implementation is dominated by computer software comprising:
a general purpose personal computer;
at least one audio video media capture card installed in said general purpose personal computer;
at least one audio video media playing card installed in said general purpose personal computer;
a plurality of multimedia code/decoder application software installed in said general purpose personal computer;
at least one internet browser installed in said general purpose personal computer;
at least one embedded Graphic User Interface (GUI) for internet feast;
at least one hard disc drive for mass audio video media storage installed in said general purpose personal computer;
at least one DVD-R/W drive for mass audio video media storage installed in said general purpose personal computer; and
a net gear that couples said feast site to internet feast platform through internet service provider.

19. The feast site box described in claim 17, wherein its implementation is dominated by semiconductor integrated circuits comprising:
a plurality of audio video input ports;
a plurality of audio video media capture circuits;
at least one multimedia processor with dual stream and full duplex features;
at least one multimedia processor with both multimedia encoding and decoding functions;
a plurality of read-only memory required by multimedia processor;
a plurality of random access memory required by multimedia processor;
a plurality of audio video media reconstruction circuits;
a plurality of audio video output ports;
at least one hard disc drive for mass audio video media storage;
at least one DVD-R/W drive for mass audio video media storage; and
a net gear that couples said feast site to internet feast platform through internet service provider.

20. The apparatus according to claim 12, wherein said feaster interface and said feast site box are integrated into one assembly comprising:
a plurality of media capture facilities that capture feast information from feasters in audio video format;
a plurality of media presentation facilities that presents feast information to feasters in audio video format;
a plurality of command input facilities that accept control information from feasters;
a plurality of information presentation facilities that interact with feasters;
capability to handles internet feast information bi-directionally;
capability to capture feast information from feasters;
capability to present feast information to feasters;
capability to process both up-stream and down-stream simultaneously;
at least one audio video media encoder that compresses media stream into lower data rate;
at least one audio video media decoder that decompresses media stream into required data rate;
at least one host microprocessor system with required memories;
at least one hard disc drive for mass audio video media storage;
at least one DVD-R/W drive for mass audio video media storage; and
a net gear that couples said feast site to internet feast platform through internet service provider.

21. The apparatus according to claim 12, wherein said feast site could further be equipped with video recording facilities so as to record and deliver feast video pictures and/or video footages to feasters, in a format of either video tape, DVD-R/W media disc, online file transfer, and/or online media sharing.
